(19) United States
(12) Patent Application Publication
(10) Pub. No.: US 2021/0333755 A1
(43) Pub. Date: Oct. 28, 2021

(54) DEVICE, SYSTEM, AND METHOD OF GROWING VIRTUAL PLANT

(71) Applicants: FUZHOU BOE OPTOELECTRONICS TECHNOLOGY CO., LTD., Fuzhou, Fujian (CN); BOE TECHNOLOGY GROUP CO., LTD., Beijing (CN)

(72) Inventors: Yabin LIN, Beijing (CN); Qiaoni WANG, Beijing (CN); Jianming HUANG, Beijing (CN); Weiqiang LI, Beijing (CN); Wanping PAN, Beijing (CN); Li CHENG, Beijing (CN); Xuezhen SU, Beijing (CN)

(73) Assignees: FUZHOU BOE OPTOELECTRONICS TECHNOLOGY CO., LTD., Fuzhou, Fujian (CN); BOE TECHNOLOGY GROUP CO., LTD., Beijing (CN)

(21) Appl. No.: 16/612,969

(22) PCT Filed: May 20, 2019
(86) PCT No.: PCT/CN2019/087546

§ 371 Date: Nov. 12, 2019

(30) Foreign Application Priority Data
May 23, 2018 (CN) 201810503659.7

(51) Int. Cl. G03H 1/00; G06F 3/01; G06K 9/00; G06F 3/0482; G06F 3/0484; G08B 21/18; G03H 1/22; G06F 21/32; G06F 16/51; G01C 9/06

(52) U.S. Cl. CPC G03H 1/0005; G01C 2009/066; G06K 9/00087; G06F 3/0482; G06F 3/04847; G08B 21/182; G03H 1/2205; G06F 21/32; G06F 16/51; G01C 9/06; G03H 2001/0088; G03H 2210/50; G03H 2223/16; G03H 2210/30; G06F 3/017

(57) ABSTRACT

A device, a system and a method of growing a virtual plant are provided. The device includes an acquisition module, configured to acquire control information; and a holographic image display module, configured to project and display a holographic image, and change a currently displayed holographic image according to the acquired control information, wherein the currently displayed holographic image includes a holographic image of a plant in a current growth stage when a user performs a planting operation including at least one of sowing the plant or maintaining the plant.

### CROSS-REFERENCE TO RELATED APPLICATION

This application claims a priority to a Chinese Patent Application No. 201810503659.7 filed in China on May 23, 2018, the disclosure of which is incorporated herein in its entirety by reference.

### TECHNICAL FIELD

The present disclosure relates to the field of virtual reality technology, and more particularly, relates to a device and a system of growing a virtual plant, and a method of growing a virtual plant.

### BACKGROUND

In a fast-developing urban society, people yearn for an idyllic peaceful life such as a flower sea in their hearts, but they do not have skills of growing and farming, lack knowledge about growing plants, and often fail to grow flowers.

### SUMMARY

The present disclosure provides a device of growing a virtual plant, a system of growing a virtual plant, and a method of growing a virtual plant.

In a first aspect, a device of growing a virtual plant is provided in the present disclosure. The device includes an acquisition module, configured to acquire control information; and a holographic image display module, configured to project and display a holographic image, and change a currently displayed holographic image according to the acquired control information, wherein the currently displayed holographic image includes a holographic image of a plant in a current growth stage when a user performs a planting operation including at least one of sowing the plant or maintaining the plant.

Optionally, the acquisition module includes at least one of: a gesture recognition unit, configured to recognize a gesture of a user to acquire the control information; or a communication unit, configured to receive the control information transmitted by the user through a mobile terminal.

Optionally, the device includes a housing including a first surface, wherein an edge of the first surface is provided with at least two laser exit ports, and the holographic image display module includes a laser modulation unit, a laser and an optical fiber splitter connected in sequence, the laser modulation unit is configured to modulate laser light emitted by the laser and to display the holographic image in front of the first surface of the housing; the optical fiber splitter is configured to split the laser light emitted by the laser and to acquire at least two beams of laser light having coherence and emitted from the at least two laser exit ports, a light overlapping region of the at least two beams of laser light in front of the first surface is a holographic image display region.

Optionally, the device further includes a fingerprint identification module on a second surface of the housing, wherein the fingerprint identification module is configured to identify a fingerprint of a user, determine a permission of the user according to the identified fingerprint of the user, and turn on the device of growing a virtual plant in a case that the permission of the user is that the user has a right to perform an operation.

Optionally, the device further includes a storage module, configured to store at least one of information of a plurality of plant types or holographic image information for displaying a holographic image by the holographic image display module.

Optionally, the communication unit is further configured to execute at least one of following (a), (b) or (c): (a) interacting at least a part of information of a plant with another user; (b) acquiring information of the plurality of plant types from an external database; (c) receiving sample information of a first plant inputted by a user, the first plant being a plant other than the plurality of plant types stored in the storage module; the holographic image information includes sample information of the plurality of plant types and information of a plurality of user operation interfaces.

Optionally, the device further includes a holographic image information conversion module, configured to convert sample information of the first plant and the plurality of plant types into holographic image information for storage in the storage module.

Optionally, the device further includes an alert module configured to alert the user in a case that a time duration for which a selected plant is not maintained exceeds a preset time duration.

Optionally, the housing is provided with a gravity sensor, the gravity sensor is connected to the holographic image display module and configured to sense information of an inclination extent of the housing and transmit the information of the inclination extent to the holographic image display module, the holographic image display module is further configured to project and display the holographic image in front of the first surface of the housing according to the information of the inclination extent transmitted by the gravity sensor.

Optionally, the holographic image display module includes: a first display unit, configured to display a holographic image of a first user operation interface in a case that the control information is first control information, wherein the first user operation interface includes virtual selection operation buttons including planting a new plant, viewing information, maintaining a plant, adding a plant and my plant; a second display unit, configured to display a holographic image of a second user operation interface including a plurality types of plant names in a case that the control information is second control information, and the second control information is used to select the virtual operation button of planting a new plant; a third display unit, configured to display a holographic image of a third user operation interface in a case that the control information is third control information, wherein the third user operation interface includes a scientific name, a living attribute, a living environment, and a maintenance technique of the selected plant, and the third control information is used to select a plant; a fourth display unit, configured to display information of a fourth user operation interface including a plurality of maintenance environment options in a case that the control information is fourth control information, and the fourth control information is used to select an add virtual operation button on the third user operation interface; a fifth display unit, configured to display growth state information of the selected plant in a case that the control information is fifth control information, wherein the fifth control information is used to select at least one of the plurality of maintenance environment options on the fourth user operation interface for completing a seeding process.

Optionally, the holographic image display module further includes a sixth display unit, configured to display information of a fifth user operation interface in a case that the control information is sixth control information; wherein the fifth user operation interface includes a maintenance environment suitable for living of the selected plant and prompt information that prompts the user how to perform a next operation, the sixth control information is used to select a default virtual operation button on the fourth user operation interface.

Optionally, the acquisition module further includes an information check unit configured to check sample information of the first plant inputted by a user, the holographic image information conversion module is further configured to generate holographic image information of the first plant and store the holographic image information of the first plant in the storage module, in a case that the information check unit passes the checking of the sample information.

In a second aspect, a system of growing a virtual plant is provided in the present disclosure. The system includes the device of growing a virtual plant according to the first aspect; a database configured to provide sample information of a plurality of plant types to the device of growing a virtual plant, and/or acquire sample information of a plant provided by a user other than sample information of the plurality of plant types; a mobile terminal including an application program, the application program being configured to provide a user with functions of maintaining a plant, setting a plant status alert, and providing sample information of a plant to the database.

In a third aspect, a method of growing a virtual plant is provided in the present disclosure. The method is applied to the device of growing a virtual plant according to the first aspect. The method includes projecting and displaying a holographic image, and changing a currently displayed holographic image according to acquired control information, wherein the currently displayed holographic image includes a holographic image of a plant at a current growth stage of the plant when a user performs a planting operation including seeding the plant and maintaining the plant.

### BRIEF DESCRIPTION OF THE DRAWINGS

FIG. 1A shows a schematic structural diagram of a device of growing a virtual plant provided in the present disclosure;

FIG. 1B-FIG. 1D show detailed schematic structural diagrams of modules in the device of growing a virtual plant provided in the present disclosure;

FIG. 2 shows a perspective view of the device of growing a virtual plant provided in the present disclosure;

FIG. 3 shows a schematic view of a first surface of a housing of the device of growing a virtual plant provided in the present disclosure;

FIG. 4 is a schematic view showing an internal structure of the device of growing a virtual plant provided in the present disclosure;

FIG. 5 is a schematic structural diagram of a system of growing a virtual plant provided in the present disclosure;

FIG. 6 shows a first flowchart of growing operations of a method of growing a virtual plant provided in the present disclosure;

FIG. 7 shows a second flowchart of growing operations of the method of growing a virtual plant provided in the present disclosure;

FIG. 8 shows an interactive schematic block diagram of the system of growing a virtual plant provided in the present disclosure.

### DETAILED DESCRIPTION

Features and principles of the present disclosure will be described in details below in conjunction with accompanying drawings. Illustrated embodiments are merely illustrative of the present disclosure and are not intended to limit the scope of the present disclosure.

There are many related software and applications on mobile phones and computers, e.g. virtual software platforms for growing flowers or trees such as a Happy Farm, an Ant Forest and the like. However, a plant grown on the platforms and a plant growing process provided by the platforms are different from actual situations, and thus cannot play roles of teaching and education; and these software platforms provide a poor ornamental property of the grown plant and cannot interact with a user.

The present disclosure provides a device and a system of growing a virtual plant and a method of growing a virtual plant. The device and the system of growing a virtual plant and the method of growing a virtual plant may solve the problem that a virtual software platform provides the poor ornamental property of a grown plant and cannot interact with a user.

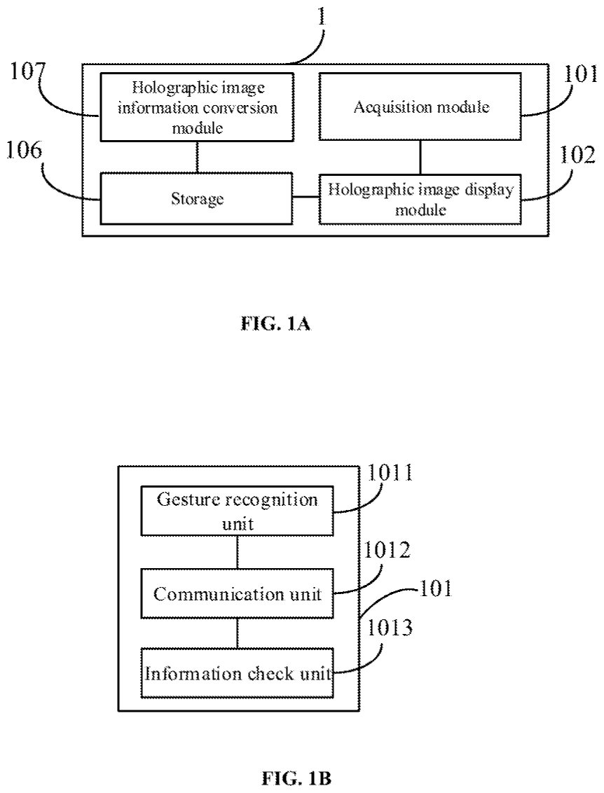

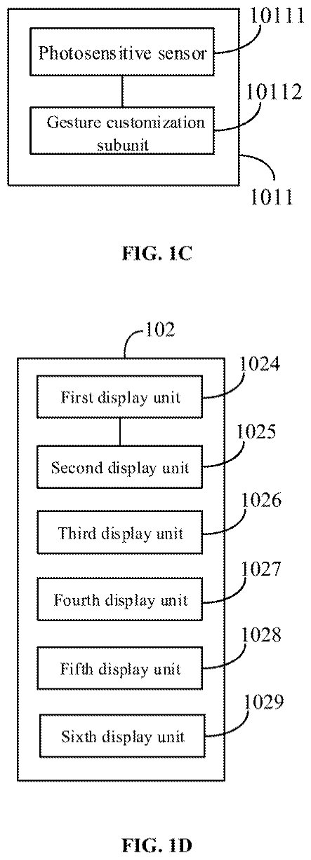

Referring to FIG. 1A, some embodiments of the present disclosure provide a device 1 of growing a virtual plant. The device includes an acquisition module 101 and a holographic image display module 102. The acquisition module 101 is configured to acquire control information. The holographic image display module 102 is configured to display a holographic image by projecting, and change, according to the acquired control information, the holographic image currently displayed, wherein the holographic image includes a holographic image of a plant at a current growth stage during a plant-growth operation including sowing the plant and maintaining the plant performed by a user.

In the present disclosure, the holographic image display module 102 displays a holographic image of a plant, and the holographic image has a stereoscopic feeling. The acquisition module 101 acquires the control information for used by the holographic image display module 102 to perform a corresponding operation, and corresponding operation interfaces are all presented by holographic images to realize a human-machine interaction and the user may perform the plant-growth operation including sowing the plant and maintaining the plant, thereby improving a sense of achievement of the user in the plant-growth operation and improving a plant-growth experience of the user.

A specific structure of the acquisition module 101 may be various, and a way of acquiring the control information may be various. Referring to FIG. 1B, in some embodiments of the present disclosure, the acquisition module 101 includes at least one of a gesture recognition unit 1011 or a communication unit 1012. The gesture recognition unit 1011 is configured to recognize a user gesture (such as a hand gesture) to acquire the control information. The communication unit 1012 is configured to receive the control information transmitted through a mobile terminal by the user.

The control information may be acquired by the gesture recognition unit 1011 performing a gesture recognition operation, thereby improving a visual perception of the user and a human-machine interaction experience effect.

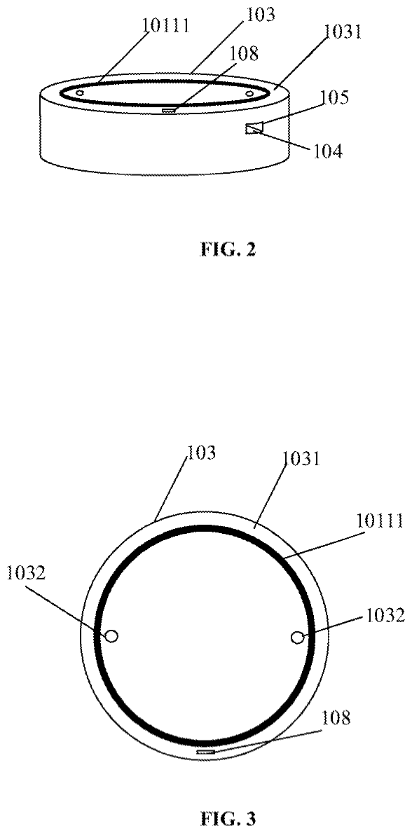

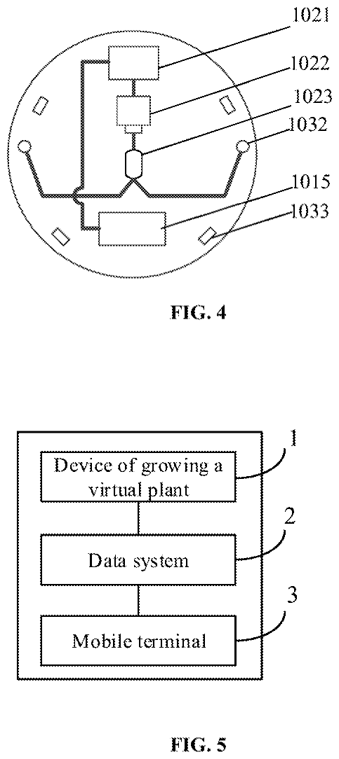

Referring to FIG. 2 and FIG. 3, FIG. 2 is a schematic view of an external structure of a device of growing a virtual plant provided in the present disclosure, and FIG. 3 is a top view of FIG. 2. In some embodiments of the present disclosure, the device of growing a virtual plant may include a housing 103 including a first surface 1031. A shape of the housing 103 may be various, for example, a cylindrical shape, a cuboid, a trapezoidal shape, or the like. The first surface 1031 may be an upper surface, a side surface, or the like of the housing 103. In some embodiments of the present disclosure, the first surface 1031 is the upper surface of the housing 103. An edge of the first surface 1031 is provided with at least two laser exit ports 1032. The at least two laser exit ports 1032 are arranged within an area defined by a photosensitive sensor 10111. Optionally, the at least two laser exit ports 1032 are centrosymmetric with respect to a center of the first surface 1031.

The gesture recognition unit 1011 includes a photosensitive sensor 10111 disposed on the first surface, but is not limited thereto.

In some embodiments of the present disclosure, the photosensitive sensor 10111 employs a CCD photosensitive surface, but is not limited thereto.

A user gesture may correspond to many functions. For example, when two fingers slide upward, the holographic image display module 102 displays a holographic display menu bar, and the user may, by clicking a corresponding virtual operation button on a menu bar using an index finger of the user, select a type of a to-be-grown plant, check maintenance data of a habit of a plant, water the plant, fertilize the plant, adjust a temperature, adjust setting of illumination, and the like.

Gesture recognition may be performed by calculating a movement trajectory, a location, a click operation, and the like of a finger, according to algorithms including, but not being limited to, an image recognition algorithm, a binocular stereo vision algorithm, and the like. A three-dimensional (3D) coordinate information of the finger may be calculated based on principles of the image recognition algorithm and the binocular stereo vision algorithm. When the finger moves, the movement trajectory of the finger may be calculated in real time. According to the movement trajectory of the finger, different gestures may be recognized, and different control information corresponding to the different gestures may be acquired. For example, an upward sliding trajectory of two fingers is to activate the menu bar, a short-distance movement of two fingers in a direction towards the housing 103 is a click operation, and control information or the like corresponding to the click operation is acquired according to a position of the click operation.

In some embodiments of the present disclosure, the gesture recognition unit 1011 includes a gesture customization subunit 10112. The gesture customization subunit 10112 is configured to enable a user to customize a gesture corresponding to a start of a function according to his/her own usage habit. The gesture customization subunit 10112 may be configured to perform at least one of following: (1) receiving gesture customization information from a mobile terminal through the communication unit 1012, or (2) collecting a gesture of a user and creating a correspondence or a mapping of the collected user gesture to a start of a function.

Optionally, the gesture customization subunit 10112 may include a camera and a storage. The camera is configured to capture a gesture of a user. The storage is configured to store a correspondence relation or a mapping relation between the captured gesture and the start of the function.

The communication unit 1012 may be configured to receive gesture control information transmitted by a mobile terminal, and to perform a corresponding operation according to the control information for purpose of facilitating use of the user. For example, the user may configure the gesture control information on an application APP of the mobile terminal and transmit the gesture control information to the device of growing a virtual plant.

Optionally, the acquisition module 101 includes the gesture recognition unit 1011 and the communication unit 1012, and the user may select a way of acquiring the control information according to actual needs.

A specific structure of the holographic image display module 102 may exhibit multiple forms as long as a holographic image may be displayed. Optionally, the holographic image display module 102 includes a laser modulator 1021, a laser 1022, and an optical fiber splitter 1023. The laser modulator 1021 is configured to modulate a laser light emitted by the laser 1022, so as to display a holographic image above the first surface 1031 of the housing 103. The optical fiber splitter 1023 is configured to split the laser light emitted by the laser 1022 so as to acquire at least two laser light beams having coherence therebetween emitted from at least two laser exit ports 1032. A light overlapping area of the at least two laser beams above the first surface 1031 is a holographic image display area.

In the present disclosure, the number of the laser exit ports 1032 may be configured according to actual needs as long as a plurality of emitted laser beams above the first surface 1031 form an interference imaging field to display a holographic image. In some embodiments, the number of the at least two laser exit ports 1032 is two.

In some embodiments of the present disclosure, the device of growing a virtual plant further includes a fingerprint identification module 104 arranged at a side of the housing 1031. The fingerprint identification module 104 is configured to identify a fingerprint of the user, judge limits of authority of a user according to the identified fingerprint, and turn on the device of growing a virtual plant in a case that the limits of authority of the user are that the user is assigned a right to perform a corresponding operation.

The fingerprint identification module 104 may act as a main switch of the device of growing a virtual plant, and/or act as a switch for turning on the gesture recognition unit 1011.

Optionally, as shown in FIG. 2, a groove 105 is provided in a side surface of the housing 103, and the fingerprint identification module 104 is disposed in the groove 105.

The fingerprint identification module 104 may be a fingerprint identification sensor, a fingerprint identification circuit, a fingerprint identification optical unit, or the like.

In some embodiments of the present disclosure, the device of growing a virtual plant 1 further includes a storage module 106 configured to store holographic image information used by the holographic image display module 102 to display a holographic image. The holographic image information includes sample information of multiple types of plants and multiple types of user operation interface information.

The sample information of the multiple types of plants includes a plant name, a growth attribute (a growth environment, a growth cycle, etc.), a maintenance method, a photograph of each growth stage, and the like.

Further, the device 1 of growing a virtual plant further includes a holographic image information conversion module 107, configured to convert the sample information of the multiple types of plants into holographic image information for storage in the storage module 106. The holographic image information may be holographic image film information. The sample information of the multiple types of plants may be acquired from an outside environment via the communication unit 1012, for example, acquired from a database 2.

The communication unit 1012 is further configured to intercommunicate information of at least some plants with other users; and/or receive sample information of a first plant inputted by a user, wherein the first plant is a plant other than the multiple types of plants stored in the storage module 106.

In some embodiments of the present disclosure, through the communication unit 1012, the user may record, in his/her own life, information of a plant not stored in the storage module 106, and perfect the database.

In some embodiments of the present disclosure, the acquisition module 101 further includes an information check unit 1013, configured to check the sample information of the first plant inputted by the user (check authenticity and integrity of the sample information of the first plant inputted by the user). If the information check unit 104 passes the checking of the sample information, the holographic image information conversion module 107 generates holographic digital negative information of the plant, and updates the holographic digital negative information to the storage module 106 for different users through the communication unit 1012. Optionally, the information check unit 1013 may be a processor and configured to be communicable with the outside via the communication unit 1012 so as to acquire complete sample information of a plant, and further, the sample information of the first plant inputted by the user may be checked as compared with the complete sample information of the plant.

In some embodiments of the present disclosure, a user providing sample information of the first plant may interact with other users through the communication unit 1012 in a shared manner, in a private manner, in a paid manner.

In some embodiments of the present disclosure, the acquisition module 101 further includes a laser data processing unit 1015 connected to the laser modulation unit 1021. The laser data processing unit 1015 is configured to generate eighth control information to control the laser modulation unit 1021, so as to realize holographic image display of corresponding holographic image information.

In some embodiments of the present disclosure, the device of growing a virtual plant further includes an alert module 108 arranged on the housing 103 and configured to emit an alert in a case that a selected plant is not cultivated for more than a preset time duration. Optionally, the alert module 108 may be an alert light or an alert speaker, and is configured to issue a warning by making a sound or flashing a light. The alert module 108 may be further configured to transmit alert information to the mobile terminal of the user through the communication unit 1012, so that the user may acquire the alert information at any time or when the user is apart from the device of growing a virtual plant.

The user may also set a corresponding alert function on an APP of the mobile terminal.

In some embodiments of the present disclosure, the housing 103 is provided with a gravity sensor 1033, and the gravity sensor 1033 is connected with the holographic image display module 102, and configured to sense an inclination extent of the housing 103 and transmit the inclination extent to the holographic image display module 102.

The holographic image display module 102 is configured to project and display a holographic image above the first surface 1031 of the housing 103 based on cause the holographic image information in the storage module 106 and according to information transmitted by the gravity sensor 1033.

An arrangement of the gravity sensor 1033 causes the virtual plant to sway with the housing 103 being swayed, thereby increasing an experience effect of the user.

As shown in FIG. 3, gravity sensors 1033 are evenly distributed at an edge of the housing 1, and in some embodiments of the present disclosure, the number of the gravity sensors 1033 is four, but not limited thereto.

In some embodiments of the present disclosure, the holographic image display module 102 further includes a first display unit 1024, a second display unit 1025, a third display unit 1026, a fourth display unit 1027, and a fifth display unit 1028. The first display unit 1024 is configured to display a holographic image of a first user operation interface in a case that the control information is first control information, wherein, the first user operation interface includes virtual selection operation buttons of planting a new plant, viewing information, maintaining a plant, adding a new plant, and my plants. The second display unit 1025 is configured to display a holographic image of a second user operation interface including a plurality types of plant names in a case that the control information is second control information, and the second control information is used to select the virtual operation button of planting a new plant. The third display unit 1026 is configured to display a holographic image of a third user operation interface in a case that the control information is third control information, wherein the third user operation interface includes a scientific name, a living attribute, a living environment, and a maintenance technique of the selected plant, and the third control information is used to select a plant. The fourth display unit 1027 is configured to display information of a fourth user operation interface including a plurality of maintenance environment options in a case that the control information is fourth control information, and the fourth control information is used to select an add virtual operation button on the third user operation interface. The fifth display unit 1028 is configured to display growth state information of the selected plant in a case that the control information is the fifth control information, the fifth control information is used to select at least one maintenance environment option on the fourth user operation interface for completing a seeding process.

In some embodiments of the present disclosure, the holographic image display module 102 further includes a sixth display unit 1029 configured to display information of a fifth user operation interface in a case that the control information is sixth control information; the fifth user operation interface includes a maintenance environment suitable for living of the selected plant and prompt information that prompts the user how to perform a next operation. The sixth control information is used to select a default virtual operation button on the fourth user operation interface.

Optionally, the first to sixth display units 1024 to 1029 may be implemented by a combination of the laser data processor unit 1015, the laser modulator 1021, the laser 1022, the optical fiber splitter 1023, the laser modulator 1021, and the laser exit port 1032.

The present disclosure also provides a system for growing a virtual plant. The system of growing a virtual plant includes at least one above-mentioned device 1 of growing a virtual plant, a database 2, and a mobile terminal 3. The database 2 is configured to provide, to the device 1 of growing a virtual plant, sample information of a plurality of types of plants including a plant name, a growth attribute (a growth environment, a growth cycle, etc.), a maintenance method, and photographs of each growth stage, etc. The database 2 may provide the sample information of the above plant to at least one device of growing the virtual plant in a wired or wireless manner. The database 2 may also acquire sample information of a plant provided by a user and different from sample information of a plurality of plants.

The mobile terminal 3 may include an application APP, configured to have functions such as my plants, maintenance of a plant, addition of a plant, a plant circle, and the like. The user may remotely, on the application APP of the mobile terminal 3, maintain a plant grown by him or her, set a plant status alert, and add new information of a plant not stored in the storage module 106 on the device 1 of growing a virtual plant or in the database 2.

The user may perform a maintenance operation in front of the device 1 of growing a virtual plant, may perform a remote operation through the application APP on the mobile terminal 3, and may carry the device 1 of growing a virtual plant with him/her.

The present disclosure also provides a method of growing a virtual plant. The method is applied to the above-described device of growing a virtual plant. The method of growing a virtual plant includes projecting and displaying a holographic image, and changing a currently displayed holographic image according to acquired control information, wherein the holographic image includes a holographic image of a plant at a current growth stage of the plant when a user performs a planting operation such as seeding the plant, maintaining the plant, and the like.

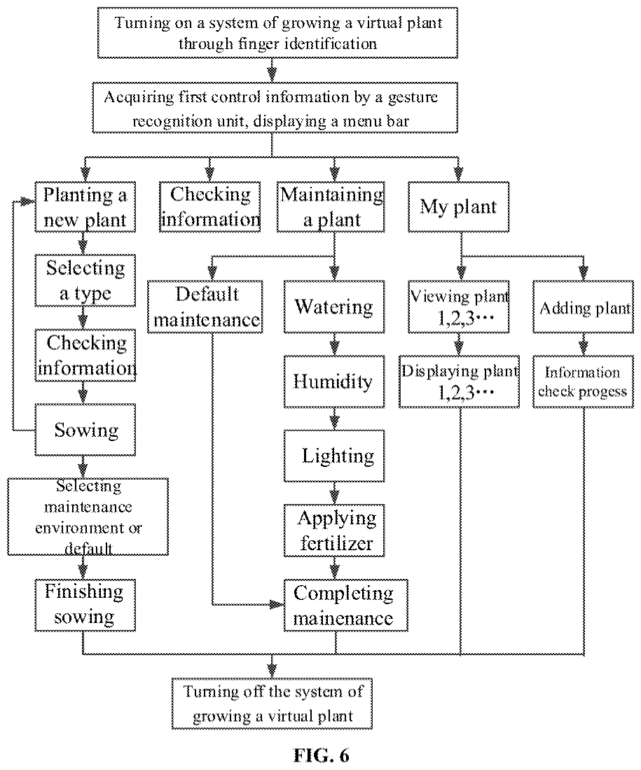

FIG. 6 shows a first flowchart of a planting operation in the method of growing a virtual plant provided by the present disclosure. The method of growing a virtual plant is applied to the device of growing a virtual plant provided by the present disclosure. A specific flow of the method of growing the virtual plant includes the following steps. The following steps are exemplary only, and other steps may exist in practical applications.

A fingerprint of a user may be identified through a fingerprint identification module, and a gesture recognition unit of the device of growing a virtual plant may be enabled to start a gesture recognition function after the fingerprint is successfully identified.

Two fingers sliding upwards above a position close to an edge of the housing (within a sensing area range of the gesture recognition unit), first control information may be acquired by the gesture recognition unit, a holographic image of a menu bar (a first user operation interface) may be displayed above the first surface, wherein the menu bar includes virtual operation buttons used for selecting to grow a new plant, viewing information, maintaining a plant, adding a plant, my plants, and the like.

The user clicks to grow a new plant, the gesture recognition unit may acquire the second control information, and a page may display a plurality of selectable flower types, in such a case, the holographic image display module may display a holographic image of a second user operation interface, wherein more flower types may be viewed through turning a page according to gesture information of sliding up and down of a finger.

When the user sees a plant type interested by him/her, the user double-clicks a corresponding name position of the plant type to select the plant type and view detailed information of the plant type, and the gesture recognition unit may acquire third control information; in such a case, the holographic image display module may display a holographic image of a third user operation interface, wherein the detailed information includes a scientific name, a living attribute, a living environment, and a maintenance technique, etc. of a plant.

The user clicks an “add” virtual operation button on the holographic image of the third user operation interface information, so that a seed of the plant enters a to-be-sown state; the gesture recognition unit may acquire fourth control information and a display page may pop up a maintenance environment selection, through which a user may select a soil type, a lighting condition, a humidity condition, and the like.

If the user does not know how to select, then the user may click “default”, and the gesture recognition unit acquires sixth control information, the system of growing the virtual plant may automatically generate a best condition suitable for survival of the plant, and gradually prompt the user how to operate, wherein if any virtual operation button is selected, a corresponding holographic image is displayed above the first surface of the housing.

With respect to a state of a grown plant, maintaining the plant may be selected on the initial display page (after the plant is grown, relevant information of the plant is displayed on the holographic image of the first user operation interface), wherein the initial display page may display virtual operation buttons such as watering, lighting, environmental humidity, applying fertilizer.

If the user finds that the storage module does not have a plant of interest, text and picture information of the plant may be searched on his/her own, the picture information needs to include pictures of each growth stage, and the searched information may be directly inputted by clicking a virtual operation button of adding a new plant, or inputted on the APP of the mobile terminal and then stored to the storage module;

The user may select a permission, such as sharing, private or paid of the inputted information. If the user selects sharing or paid, the processing module may strictly check authenticity of the inputted information, and update the information to the storage module after the checking of the authenticity is passed. In addition, the holographic image information conversion module generates holographic digital image negative information for being downloaded and used by all users through the communication unit. A shared plant may be used free of charge. A plant needing payment may be used after the payment is performed, wherein a user who provides the information of the plant may acquire 95% of income of the payment. If a plant is selected to be private, then the processing module may perform a brief check on integrity of information and update the information to a storage module of the user for use by the user himself/herself.

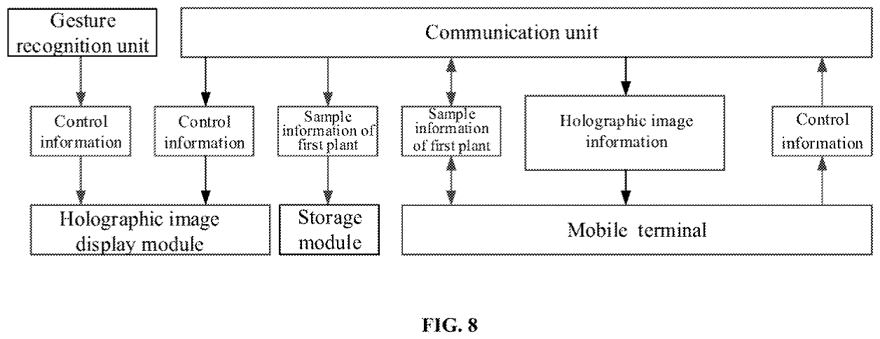

Interactions among the storage module, the communication unit, the gesture recognition unit, and the mobile terminal are shown in FIG. 8.

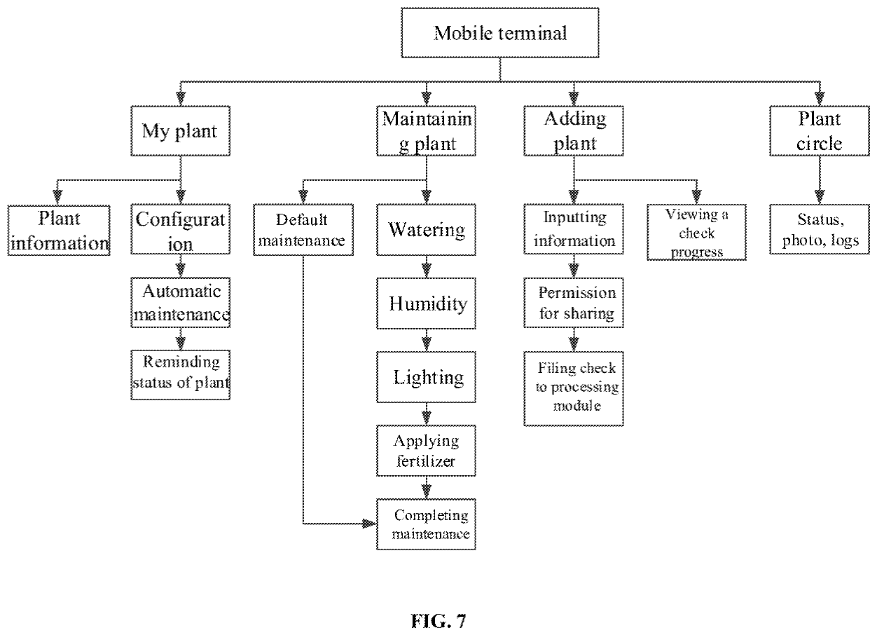

FIG. 7 shows a schematic flow chart of growing operations in the method of growing a virtual plant provided by the present disclosure. The method of growing a virtual plant may be applied to the system of growing the virtual plant provided by the present disclosure. The application APP on the mobile terminal includes functions such as my plants, maintaining a plant, adding a plant, a plant circle, etc. The user may remotely maintain the plant grown by him/her, set a plant status alert, add a plant not stored in the database, and so on, through the mobile terminal.

The user may shake the housing. Due to the arrangement of the gravity sensor, the holographic image of the plant will also sway with the shaking of the housing, thereby increasing an effect of the user experience.

The user may recognize a gesture through a gesture recognition unit so as to acquire control information for performing a maintenance operation, or may receive control information transmitted from a mobile terminal (e.g., an application APP of the mobile terminal) through the communication unit and perform a remote operation. Once the plant is planted, the system of growing a virtual plant updates a status of the plant at all times, regardless of the device of growing a virtual plant being powered off or turned on. If the plant is not maintained for more than a preset time duration, the device of growing a virtual plant may issue an alert by the alert module provided on the housing, or the alert is issued on the mobile terminal. If the alert is ignored for a long time, and the plant is not maintained, then the virtual plant will eventually die as well.

The present disclosure uses a holographic projection to realize a stereoscopic presentation of a plant, and may interact with human to realize growing operations such as growing and maintaining a plant, thereby improving a growing experience of a user.

What is described above are optional embodiments of the present disclosure. It should be noted that, for those of ordinary skills in the art, several modifications and refinements may be made without departing from the principle of the present disclosure. These modifications and refinements should also be considered to be within the scope of the present disclosure.

1. A device of growing a virtual plant, comprising:
an acquisition module, configured to acquire control information; and
a holographic image display module, configured to project and display a holographic image, and change a currently displayed holographic image according to the acquired control information,
wherein the currently displayed holographic image comprises a holographic image of a plant in a current growth stage when a user performs a planting operation comprising at least one of sowing the plant or maintaining the plant.

2. The device of growing a virtual plant according to claim 1, wherein the acquisition module comprises at least one of:
a gesture recognition unit, configured to recognize a gesture of a user to acquire the control information; or
a communication unit, configured to receive the control information transmitted by the user through a mobile terminal.

3. The device of growing a virtual plant according to claim 1, comprising:
a housing comprising a first surface,
wherein an edge of the first surface is provided with at least two laser exit ports, and the holographic image display module comprises a laser modulation unit, a laser and an optical fiber splitter connected in sequence,
the laser modulation unit is configured to modulate laser light emitted by the laser and to display the holographic image in front of the first surface of the housing,
the optical fiber splitter is configured to split the laser light emitted by the laser and to acquire at least two beams of laser light having coherence and emitted from the at least two laser exit ports, a light overlapping region of the at least two beams of laser light in front of the first surface is a holographic image display region.

4. The device of growing a virtual plant according to claim 1, further comprising:
a fingerprint identification module on a second surface of the housing,
wherein the fingerprint identification module is configured to identify a fingerprint of a user, determine a permission of the user according to the identified fingerprint of the user, and turn on the device of growing a virtual plant in a case that the permission of the user is that the user has a right to perform an operation.

5. The device of growing a virtual plant according to claim 2, further comprising:
a storage module, configured to store at least one of information of a plurality of plant types or holographic image information for displaying a holographic image by the holographic image display module.

6. The device of growing a virtual plant according to claim 5, wherein the communication unit is further configured to execute at least one of following (a), (b) or (c):
(a) interacting at least a part of information of a plant with another user;
(b) acquiring information of the plurality of plant types from an external database;
(c) receiving sample information of a first plant inputted by a user, the first plant being a plant other than the plurality of plant types stored in the storage module;
the holographic image information comprises sample information of the plurality of plant types and information of a plurality of user operation interfaces.

7. The device of growing a virtual plant according to claim 6, further comprising:
a holographic image information conversion module, configured to convert sample information of the first plant and the plurality of plant types into holographic image information for storage in the storage module.

8. The device of growing a virtual plant according to claim 1, further comprising:
an alert module, configured to alert the user in a case that a time duration for which a selected plant is not maintained exceeds a preset time duration.

9. The device of growing a virtual plant according to claim 3, wherein the housing is provided with a gravity sensor, the gravity sensor is connected to the holographic image display module and configured to sense information of an inclination extent of the housing and transmit the information of the inclination extent to the holographic image display module,
the holographic image display module is further configured to project and display the holographic image in front of the first surface of the housing according to the information of the inclination extent transmitted by the gravity sensor.

10. The device of growing a virtual plant according to claim 1, wherein the holographic image display module comprises:
a first display unit, configured to display a holographic image of a first user operation interface in a case that the control information is first control information, wherein the first user operation interface comprises virtual selection operation buttons comprising planting a new plant, viewing information, maintaining a plant, adding a plant and my plant
a second display unit, configured to display a holographic image of a second user operation interface comprising a plurality types of plant names in a case that the control information is second control information, and the second control information is used to select the virtual operation button of planting a new plant;
a third display unit, configured to display a holographic image of a third user operation interface in a case that the control information is third control information, wherein the third user operation interface comprises a scientific name, a living attribute, a living environment, and a maintenance technique of the selected plant, and the third control information is used to select a plant;
a fourth display unit, configured to display information of a fourth user operation interface comprising a plurality of maintenance environment options in a case that the control information is fourth control information, and the fourth control information is used to select an add virtual operation button on the third user operation interface;
a fifth display unit, configured to display growth state information of the selected plant in a case that the control information is fifth control information, wherein the fifth control information is used to select at least one of the plurality of maintenance environment options on the fourth user operation interface for completing a seeding process.

11. The device of growing a virtual plant according to claim 10, wherein the holographic image display module further comprises:
a sixth display unit, configured to display information of a fifth user operation interface in a case that the control information is sixth control information;
wherein the fifth user operation interface comprises a maintenance environment suitable for living of the selected plant and prompt information that prompts the user how to perform a next operation, the sixth control information is used to select a default virtual operation button on the fourth user operation interface.

12. The device of growing a virtual plant according to claim 7, wherein the acquisition module further comprises an information check unit configured to check sample information of the first plant inputted by a user,
the holographic image information conversion module is further configured to generate holographic image information of the first plant and store the holographic image information of the first plant in the storage module, in a case that the information check unit passes the checking of the sample information.

13. A system of growing a virtual plant, comprising:
the device of growing a virtual plant according to claim 1;
a database configured to provide sample information of a plurality of plant types to the device of growing a virtual plant, and/or acquire sample information of a plant provided by a user other than sample information of the plurality of plant types;
a mobile terminal comprising an application program, the application program being configured to provide a user with functions of maintaining a plant, setting a plant status alert, and providing sample information of a plant to the database.

14. A method of growing a virtual plant, the method being applied to the device of growing a virtual plant according to claim 1, the method comprising:
projecting and displaying a holographic image, and changing a currently displayed holographic image according to acquired control information, wherein the currently displayed holographic image comprises a holographic image of a plant at a current growth stage of the plant when a user performs a planting operation comprising seeding the plant and maintaining the plant.

15. The device of growing a virtual plant according to claim 2, comprising:
a housing comprising a first surface,
wherein an edge of the first surface is provided with at least two laser exit ports, and the holographic image display module comprises a laser modulation unit, a laser and an optical fiber splitter connected in sequence,
the laser modulation unit is configured to modulate laser light emitted by the laser and to display the holographic image in front of the first surface of the housing,
the optical fiber splitter is configured to split the laser light emitted by the laser and to acquire at least two beams of laser light having coherence and emitted from the at least two laser exit ports, a light overlapping region of the at least two beams of laser light in front of the first surface is a holographic image display region.

16. The device of growing a virtual plant according to claim 2, further comprising:
a fingerprint identification module on a second surface of the housing,
wherein the fingerprint identification module is configured to identify a fingerprint of a user, determine a permission of the user according to the identified fingerprint of the user, and turn on the device of growing a virtual plant in a case that the permission of the user is that the user has a right to perform an operation.

17. The device of growing a virtual plant according to claim 3, further comprising:
a fingerprint identification module on a second surface of the housing,
wherein the fingerprint identification module is configured to identify a fingerprint of a user, determine a permission of the user according to the identified fingerprint of the user, and turn on the device of growing a virtual plant in a case that the permission of the user is that the user has a right to perform an operation.
